(19) United States
(12) Patent Application Publication
(10) Pub. No.: US 2014/0292054 A1
(43) Pub. Date: Oct. 2, 2014

(54) COMPONENT FOR A VEHICLE SEAT

(71) Applicants: Wolfgang Pluta, Heiligenmoschel (DE); Lars Kramm, Trippstadt (DE); Harald Wolsiefer, Krickenbach (DE)

(72) Inventors: Wolfgang Pluta, Heiligenmoschel (DE); Lars Kramm, Trippstadt (DE); Harald Wolsiefer, Krickenbach (DE)

(73) Assignee: KEIPER GMBH & CO. KG

(21) Appl. No.: 14/110,126

(22) PCT Filed: Mar. 30, 2012
(86) PCT No.: PCT/EP2012/055845

§ 371 Date: Dec. 27, 2013

(30) Foreign Application Priority Data
Apr. 4, 2011 (DE) 10 2011 016 654.8

(51) Int. Cl. B60N 2/22; B60N 2/44

(52) U.S. Cl. CPC B60N 2/22; B60N 2/44
USPC 297/354.1; 297/463.1

(57) ABSTRACT

A component, in particular for a vehicle scat, has an opening for the fastening of the component, the opening having a centre point and a radius. The component is locally hardened at at least one point in the vicinity of the opening and at a distance from the opening. The vicinity of the opening is a region around the centre point with a radius of up to four times the radius of the opening.

The invention relates to a component, in particular for a vehicle seat, with the characteristics of the preamble of the claim 1.

A component of this type is known from WO 2009103641 A2. The component is designed as an adapter for a fitting, which serves to set the incline of the backrest of a vehicle seat. The component is welded to the fitting on one side and has two openings on the other side, which serve to fasten it on the seat frame. A known fastening takes place by means of screws. It is further known to achieve a reinforcement of the edge of the openings through collar passages or adjustments or higher-tensile or thicker material.

The object of the invention is to improve a component of the initially named type in an installation-space-optimized and/or cost-effective manner with respect to strength. This object is solved according to the invention through a component with the characteristics of claim 1. Advantageous embodiments are the subject of the dependent claims.

The opening receives a fastening means, by means of which the component is fastened on another component. The local hardening of the component at a distance to the opening restricts the bearing stress generated by means of the fastening means, which can occur due to forces between the component and the other component. The reinforcement of the vicinity of the opening takes place according the Damascus steel principle: a soft region around the opening reduces energy and protects from the formation of cracks. The locally hardened region brings the strength. An overall lighter, more cost-effective and installation-space-optimized structure results from the omission of collar passages, adjustments and higher-tensile or thicker material. The radius of the screws can be reduced, e.g. from 12 mm to 10 mm.

The local hardening is preferably created by means of a welded seam, which is preferably generated by means of a laser or in another manner. However, other techniques are also conceivable for the local hardening, for example a locally restricted carbonization. A welded seam is not just a melted and re-solidified region, but in particular any locally hardened region created by means of thermal processing (in particular through a laser beam).

One welded seam or several welded seams can be provided. In the latter case, the welded seams are distanced from each other and preferably designed at a constant distance from each other. The shape of the welded seam depends on the expected load, i.e. on the expected flux of force. The welded seam can be closed or discontinuous on a closed base line (or only formed in sections) or open. Circular, arched, oval or spiral welded seams are conceivable, which revolve around the centre point at least in sections at a distance from the centre point that is greater than the radius of the opening or proceed around a centre of curvature displaced for this. But linearly progressing welded seams are also conceivable, which preferably proceed towards the opening parallel to a tangent, that is perpendicular to the distribution of force, and are thereby cut by the elongation of the radius through the boundary point of the tangent in particular in the centre of the welded seam.

The opening is preferably cylindrical with a circular cross-section, wherein the material of the component has a constant thickness in the vicinity of the opening (including the edge of the opening), at least approximately. But the opening can also have another cross-section; for example, it can be hexagonal, oval or elliptical. The terms “centre point” and “radius” are to be understood in terms of the cross-section, for example “centre point” as the centre of the region and “radius” as the average distance between the edge of the opening and the centre. If the fastening means is a screw or a rivet, and the head of this fastening means has a head, then the distance between the locally hardened point and the centre point of the opening is preferably greater than the radius of the head. The screwing on is thus securely performable without for example being influenced by rough surfaces or bulges in the welded seam.

The invention is preferably usable in components of a vehicle seat of a motor vehicle to be screwed or riveted on but can also be used for other purposes.

The invention is explained in greater detail below based on seven exemplary embodiments shown in the drawing. They show in

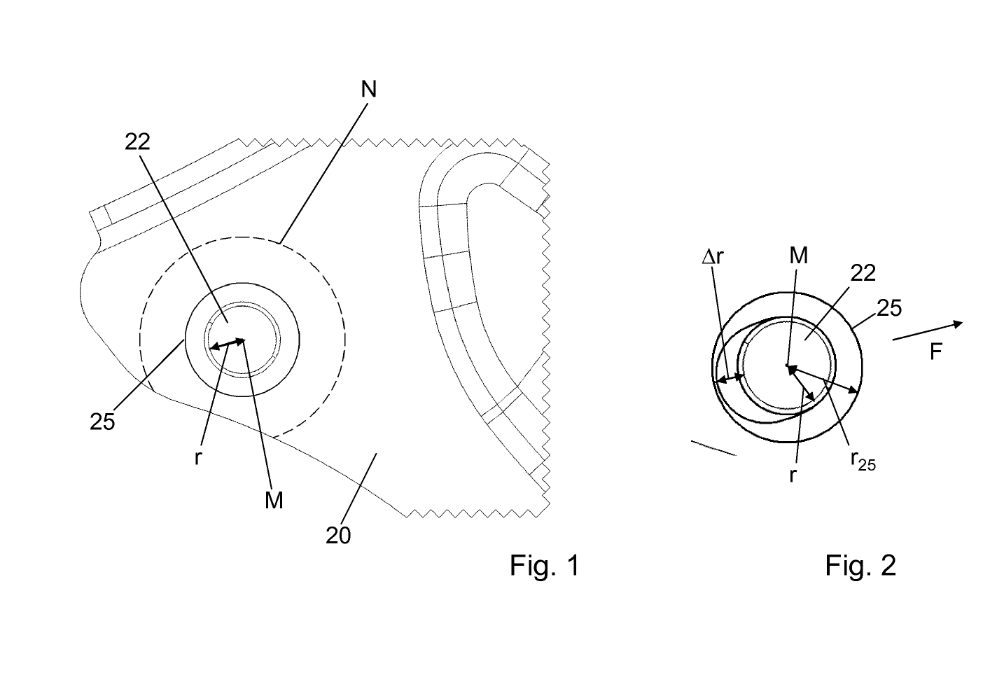

FIG. 1 a partial view of the first exemplary embodiment,

FIG. 2 a representation of the bearing stress of the first exemplary embodiment,

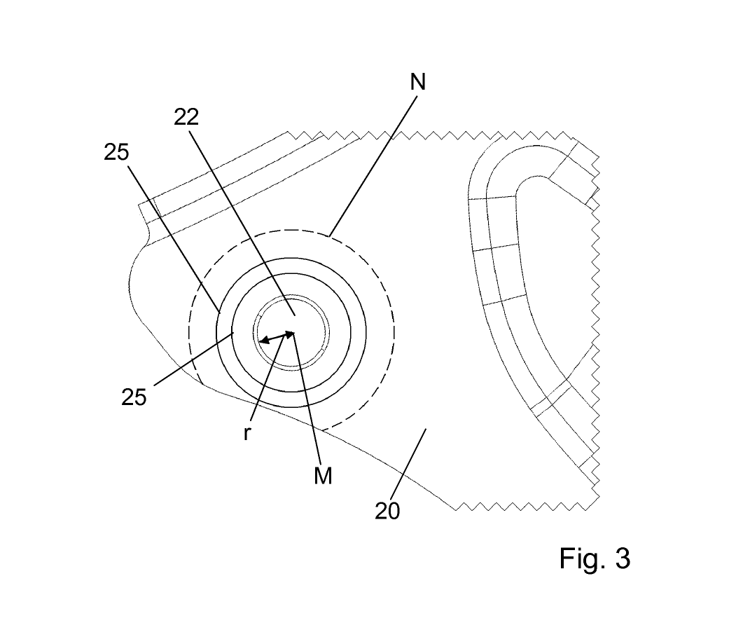

FIG. 3 a partial view of the second exemplary embodiment,

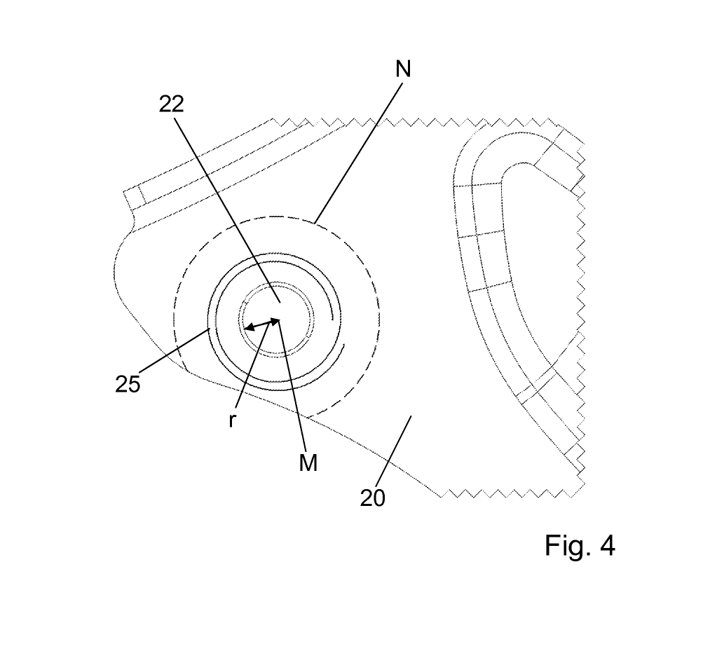

FIG. 4 a partial view of the third exemplary embodiment,

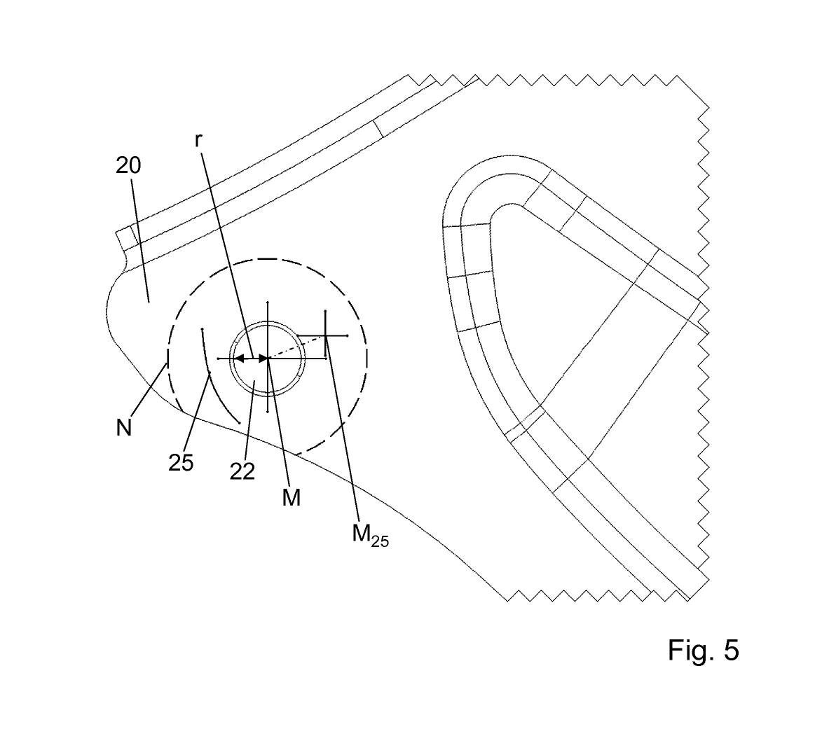

FIG. 5 a partial view of the fourth exemplary embodiment,

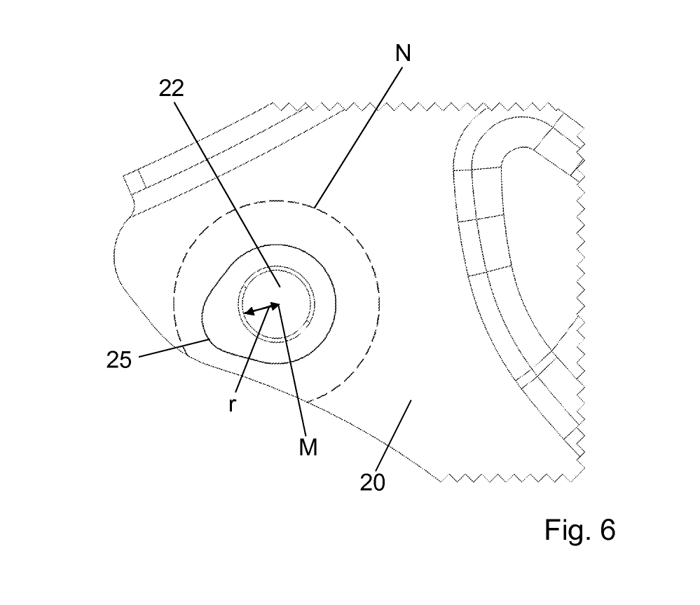

FIG. 6 a partial view of the fifth exemplary embodiment,

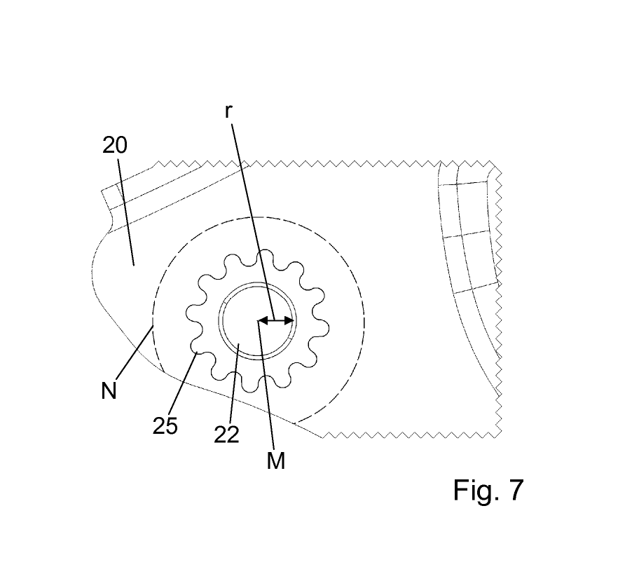

FIG. 7 a partial view of the sixth exemplary embodiment,

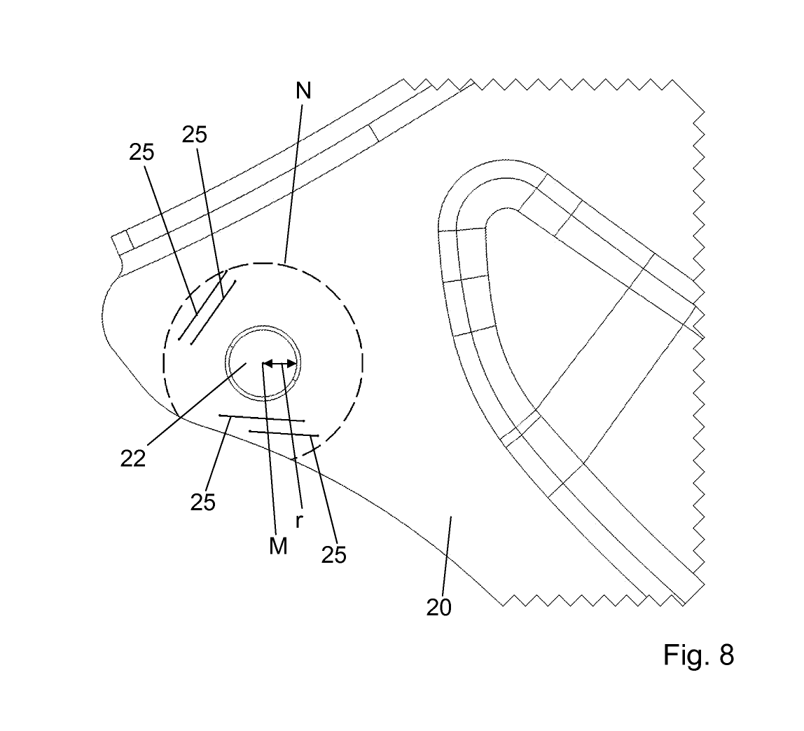

FIG. 8 a partial view of the seventh exemplary embodiment,

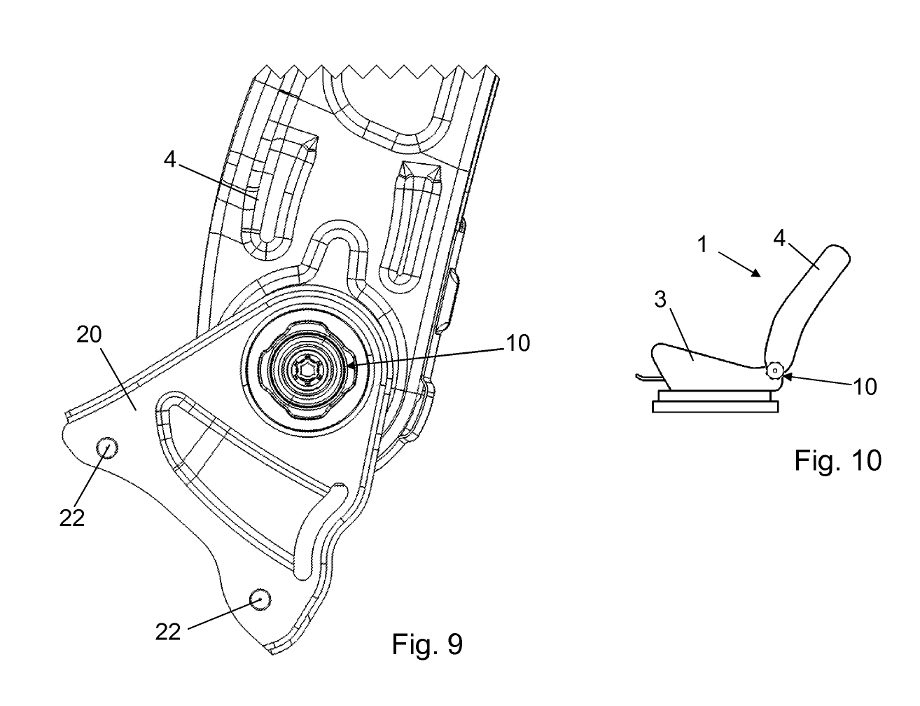

FIG. 9 a view of a fitting with the component according to the invention and

FIG. 10 a schematic representation of a vehicle seat.

A vehicle seat 1 for a motor vehicle has a seat part 3 and a backrest 4, which is adjustable in its incline relative to the seat part 3. For this incline adjustment, the vehicle seat 1 preferably has a fitting 10 on each side (FIG. 10). The vehicle seat 1 has a component 20 as part of its load-bearing structure. The component 20 is made of a hardenable steel. The component 20 can be for example a fitting part of the fitting 10 or an adapter on the fitting 10 (FIG. 9). The component 20 is fastened on another component of the vehicle seat 1, for example on the seat frame of the seat part 3, by means of screwing on or, if applicable, riveting on.

For the fastening, the component 20 has at least one opening 22, which is penetrated during the fastening of the screw or the rivet. In the exemplary embodiments, the opening 22 has—at least before the fastening—a circular cross-section with a centre point M and a radius r. In the region around the opening 22, the thickness of the component 20, that is its material strength, is constant, at least approximately. The opening 22 is thus a constant radius material recess in the component 20. Accordingly, the edge of the opening 22 is a cylinder shell.

The component 20 is locally hardened before the fastening in the region of the opening 22. For this, a laser is preferably used, which has an infeed and preferably offers the option of an oscillation diagonally to the infeed direction. The laser beam is preferably focused on a spot size of 0.05 mm to 0.2 mm, especially preferably 0.05 mm to 0.1 mm. By means of the laser, at least one welded seam 25 is created, for example by means of fibre laser welding or by means of high-power diode laser hardening. The welded seam 25 is a bead on plate weld, i.e. the welded seam 25 does not connect two components with each other. Due to the melting and solidification of the material of the component 20, the component 20 is hardened locally, namely in the region of the welded seam 25 due to the formation of the welded seam 25. The welded seam 25 is formed at a distance from the opening 22 but at a point in the vicinity N of the opening 22. Vicinity N of the opening 22 is a—preferably annular—region around the centre point M with an (outer) radius of two to four times the radius r of the opening 22, preferably an (outer) radius of two to three times the radius r of the opening 22. In the exemplary embodiments, the radius of the vicinity N is three times the radius r of the opening 22. The vicinity N is completed on the inside with the edge of the opening 22. If the distance between the opening 22 and the edge of the component 20 is less than the radius of the vicinity N of the opening 22 in some places, the vicinity N of the opening 22 has a shape deviating from that of a ring.

If the locally hardened component 20 is fastened on the other component, occurring forces, in particular compressive forces, may cause bearing stress on the opening 22: the screw or the bolt pushes against the edge of the opening 22 so that the material of the component 20 gives way there and deforms. In the case of unhardened components, the bearing stress compared to the radius r of the opening 22 can be 50% or more and can lead to the formation of cracks. Due to the local hardening of the component 20, the welded seam 25 forms a boundary for the bearing stress, i.e. as soon during the bearing stress as the deformation of the component 20 hits the hardened region, here the welded seam 25, the deformation is slowed and ideally stopped. Further deformation is only possible under a considerably higher load level.

Several designs are possible for the shape of the welded seam 25, several examples of which are described below.

The first exemplary embodiment (FIGS. 1 and 2) shows a single welded seam 25. The welded seam 25 progresses circularly around the centre point M, that is concentrically to the opening 22 (i.e. concentrically to its edge). The radius of the welded seam 25 is marked with r25. If a force F now acts upon the component 20, which loads the component 20 with respect to the screw or the bolt in the opening 22, then the bearing stress occurs. In the direction of the force F, the dimension of the opening 22 increases from 2×r by the elongation Δr. The occurring tension P is P=F(2×r×t), wherein t is the thickness of the component in the region of the opening 22. The expansion D is D=(rn+2×Δr) (rn). So that the expansion D is less than the maximum breaking elongation, r25−r must (in the presently calculated ideal case) be less than the permissible elongation, i.e. the elongation Δr may only reach up to the welded seam 25.

The second exemplary embodiment (FIG. 3) shows exactly two welded seams 25. The two welded seams 25 progress—each with a different radius with respect to the radius r of the opening 22—circularly around the centre point M, that is concentrically to the opening 22.

The third exemplary embodiment (FIG. 4) shows a single welded seam 25, which progresses in a spiral manner around the centre point M, and preferably with exactly two coils. This embodiment has the advantage over the two welded seams 25 in the second embodiment that there is no interruption, i.e. the welded seam 25 can be designed without a pause.

The fourth exemplary embodiment (FIG. 5) shows a single welded seam 25. The welded seam 25 progresses in an arched manner over an angle of for example 50° around a centre of curvature M25 displaced towards the centre point M. The curvature radius M25 is for example three to four times larger than the radius r of the opening 22. The expected load direction progresses in elongation of the connection line between the centre point M and the centre of curvature M25 of the welded seam 25.

The fifth exemplary embodiment (FIG. 6) shows a single welded seam 25. The welded seam 25 progresses in an oval manner around the opening 22, here with a pointed end, a blunt end and a symmetrical axis. In the direction of the pointed end, a greater deformation of the material of the component 20 can take place. In modifications, the progression of the welded seam 25 can be cam-shaped, eccentric or otherwise asymmetrical relative to the oval in FIG. 6.

The sixth exemplary embodiment (FIG. 7) shows a single welded seam 25. The oscillation capability of the laser is used in this design. The welded seam 25 thus swings around a base line, which progresses in a circular manner around the centre point M, that is concentrically to the opening 22. The drawing is only schematic. As a rule, the oscillation frequency will be considerably higher. Theoretically, an expansion of the component 20 is possible in the circumferential direction of the base line.

The seventh exemplary embodiment (FIG. 8) shows at least one pair of linear, parallel welded seams 25, for example two pairs. The provided pairs progress parallel to an imaginary tangent towards the opening 22. The typical crack formation takes place radially from the opening 22 so that the welded seams 25 are arranged at least approximately perpendicular to these expected cracks and stop them from expanding.

### LIST OF REFERENCES

1 Vehicle seat
3 Seat part
4 Backrest
10 Fitting
20 Component
22 Opening
25 Welded seam
F Force
M Centre point of the opening 22
M25 Centre of curvature of the welded seam 25
N Vicinity
r Radius of the opening 22
r25 Radius of the welded seam 25
Δr Elongation of the opening 22 through bearing stress

1. A component for a vehicle seat, comprising:
an opening for the fastening of the component, said opening having a centre point and a radius, wherein the component is locally hardened at at least one point in the vicinity of the opening and at a distance from the opening, wherein the vicinity of the opening is a region around the centre point with a radius of up to four times the radius of the opening.

2. The component according to claim 1, wherein the component is locally hardened by at least one welded seam.

3. The component according to claim 2, wherein the at least one welded seam progresses circularly around the centre point.

4. The component according to claim 2, wherein the at least one welded seam progresses in a spiral or oval or arched manner around the centre point or around a centre of curvature displaced towards the centre point.

5. The component according to claim 2, wherein the at least one welded seam oscillates around a base line, which revolves circularly around the centre point.

6. The component according to claim 2, wherein the at least one welded seam progresses linearly.

7. The component according to claim 1, wherein the component is locally hardened by a laser.

8. The component according to claim 1, wherein the component in the vicinity of the opening has an at least approximately constant thickness.

9. The component according to claim 1, wherein the opening serves to receive a screw or a rivet, wherein the distance between the locally hardened point and the centre point greater than the radius of the screw or rivet head.

10. A vehicle seat with at least one component according to claim 1, which is a part of a fitting for the incline adjustment of the backrest of the vehicle seat.
